(19) United States
(12) Patent Application Publication
(10) Pub. No.: US 2025/0139238 A1
(43) Pub. Date: May 1, 2025

(54) SECURITY ENHANCEMENT FOR COMPUTING DEVICE STATE CHANGE

(71) Applicant: Microsoft Technology Licensing, LLC, Redmond, WA (US)

(72) Inventors: Assaf BAR - NESS, Rehovot (IL); Shoham DEKEL, Tel Aviv (IL)

(21) Appl. No.: 18/497,664

(22) Filed: Oct. 30, 2023

(51) Int. Cl. G06F 21/55; G06F 21/57; G06F 21/62

(52) U.S. Cl. CPC G06F 21/554; G06F 21/577; G06F 21/6245

(57) ABSTRACT

Systems and methods are disclosed herein for identifying a bypass of a computing device state change. In an example system, a determination is made that a computing component, such as an application executing on the computing device, is blocking a state change of the computing device. The state change includes various types of actions to protect the computing device, such as an automatic lock, logoff, standby mode change, or powering off change. An idle period of the computing device is detected. A proximity change of a user relative to the computing device is also detected. Based on the idle period and the proximity change, an action to remediate the blocking of the state change is performed, such as generating a notification associated with the blocking of the state change for providing to the user and/or automatically bypassing the blocking of the state change.

### BACKGROUND

Use of computing devices has become ubiquitous for various applications and various environments. In many instances, computing devices provide access to data that is sensitive, or otherwise not intended for viewing by individuals other than the user of the computing device. This data can include personal identifiable information (PII), healthcare information, financial information, business information, or other types of data that is not otherwise intended for public dissemination. One common technique for maintaining the sensitivity of such data is by locking the computing device when the device is no longer in use.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems and methods are disclosed herein for identifying a bypass of a computing device state change. In an example system, a determination is made that a computing component, such as an application executing on the computing device, is blocking a state change of the computing device. The state change includes various types of actions to protect the computing device, such as an automatic lock, logoff, standby mode change, or powering off change. An idle period of the computing device is detected. A proximity change of a user relative to the computing device is also detected. Based on the idle period and the proximity change, an action to remediate the blocking of the state change is performed, such as generating a notification associated with the blocking of the state change for providing to the user and/or automatically bypassing the blocking of the state change.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of system for identifying a bypass of a computing device state change, in accordance with an example embodiment.

FIG. 2 block diagram of another system for identifying a bypass of a computing device state change, in accordance with an example embodiment.

FIG. 3 shows a flowchart of a method for identifying a bypass of a state change of a computing device, in accordance with an example embodiment.

FIG. 4 shows a flowchart of a method for transmitting a notification as a remediation action, in accordance with an example embodiment.

FIG. 5 shows a flowchart of a method for accessing a security policy to identify a remediation action based on a sensitivity of data, in accordance with an embodiment.

FIG. 6 shows a block diagram of a system for identifying a remediation action based on a sensitivity of data accessible on a computing device, in accordance with an example embodiment.

FIG. 7 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Use of computing devices has become ubiquitous for various applications and various environments. In many instances, computing devices provide access to data that is sensitive, or otherwise not intended for viewing by individuals other than the user of the computing device. This data can include personal identifiable information (PII), healthcare information, financial information, business information, or other types of data that is not otherwise intended for public dissemination. One common technique for maintaining the sensitivity of such data is by locking the computing device when the device is no longer in use.

In one scenario, a user can trigger the computing device to lock manually by activating a lock function on the computing device (e.g., due to a policy set on the computing device based on personal or company requirements). In another scenario, a computing device can automatically lock itself based on certain factors, such as a lack of a human presence. However, various types of applications executing on the computing device can prevent the device from locking automatically. For instance, a video player application may block the computing device from locking itself to ensure uninterrupted playback or an active telephone call may prevent the locking of the device. When such applications are executing, the device fails to lock itself, even when a user has moved away from the device. In addition, users are often unaware of which applications prevent a device from automatically locking or may forget about blocking applications that are executing in the background, resulting in users incorrectly assuming that their device will lock automatically. In these situations, the risk of exposure of the data accessible on computing device greatly increases, which can be especially problematic where the data is sensitive. Unless a user manually confirms a lock status of their computing device each time they step away, existing mechanisms for automatically locking a device are insufficient to protect data that is accessible on the computing device.

Embodiments described herein are directed to identifying a bypass of a computing device state change. In an example system, a determination is made that a computing component, such as an application executing on the computing device, is blocking a state change of the computing device. The state change includes various types of actions to protect the computing device, such as an automatic lock, logoff, standby mode change, or powering off change. An idle period of the computing device is detected. A proximity change of a user relative to the computing device is also detected. Based on the idle period and the proximity change, an action to remediate the blocking of the state change is performed, such as generating a notification associated with the blocking of the state change for providing to the user and/or automatically bypassing the blocking of the state change. Accordingly, example embodiments are directed to techniques for identifying instances where a computing component is blocking a device state change of a computing device, and remediating such blocking. As such, example embodiments described herein advantageously provide improvements in various areas of computing, including but not limited to, improvements to data security of computing devices. For instance, example techniques described herein allow for determining when a computing device is unable to lock due to the execution of an application, and performing one or more actions to improve the security of the device based on such a determination. These actions include, but are not limited to, automatically overriding the application that is blocking the state change of the computing device and/or notifying a user of the computing device, who may take further action to address the blocking of the state change. By identifying these instances and addressing the blocking of the state changes with various types of actions, the risk of unintended disclosure of data accessible on the computing device can be mitigated or even prevented, thereby improving data security of computing devices.

Still further, when the data (or other application or services) accessible on the computing device are accessible via a cloud or other network, techniques described herein allow for mitigating the access of such data over a network, which can additionally enhance the security of other devices communicatively coupled to the computing device in which the state change is being blocked.

Still further, mitigating the access of such data can be carried out in various ways, such as by automatically overriding application that is blocking the application (either automatically or via a signal received from a user), allowing the computing device to force the state change, such as entering a standby or hibernation mode where computing operations are minimized (or even ceased). As a result, example embodiments enable improvements to the security of computing devices as well as allow for a reduction in computing resources utilized overall (e.g., by reducing processing cycles due to terminating the blocking application, entering a low-power state, etc.). Further, by performing various types of remediation actions, unintended network-based access of computing devices can also be prevented (e.g., to exfiltrate sensitive information), thereby reducing network traffic as well.

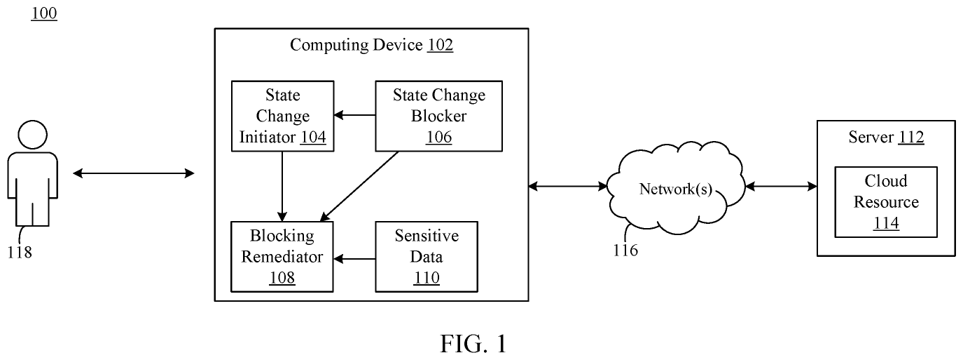

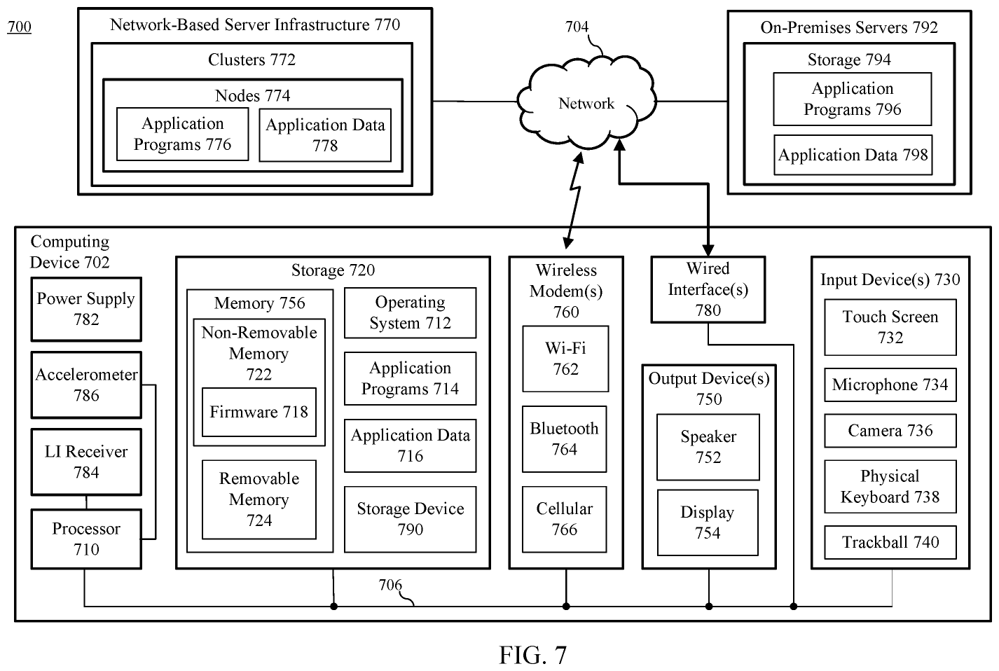

Embodiments for identifying a bypass of a computing device state change are implemented in various way. For instance, FIG. 1 shows a block diagram of system 100 for identifying a bypass of a computing device state change, according to an example embodiment. As shown in FIG. 1, system 100 includes a computing device 102, a server 112, a network 116, and a user 118. Computing device 102 includes a state change initiator 104, a state change blocker 106, a blocking remediator 108, and sensitive data 110. Server 112 includes a cloud resource 114. An example device that may incorporate the functionality of computing device 102 and/or server 112 (or any subcomponents therein, whether or not illustrated in FIG. 1) is described below in reference to FIG. 7. It is noted that system 100 may comprise any number of devices, including those illustrated in FIG. 1 and optionally one or more further devices or components not expressly illustrated. System 100 is further described as follows.

In an example implementation, network 116 includes one or more of any of a local area network (LAN), a wide area network (WAN), a personal area network (PAN), a combination of communication networks, such as the Internet, and/or a virtual network. In example implementations, computing device 102 and server 112 communicate via network 116. In an implementation, any one or more of computing device 102 and/or server 112 communicate over network 116 via one or more application programming interfaces (API) and/or according to other interfaces and/or techniques. In an example, computing device 102 and/or server 112 each include at least one network interface that enables communications with each other. Examples of such a network interface, wired or wireless, include an IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, a near field communication (NFC) interface, etc. Further examples of network interfaces are described elsewhere herein.

Computing device 102 includes any number of one or more computing devices of one or more users (e.g., individual users, family users, enterprise users, governmental users, etc.) that each comprise one or more applications, operating systems, virtual machines, storage devices, etc. used to retrieve, view, modify, transmit, or otherwise access data stored thereon or on another computing device. Computing device 102 comprises any type of stationary or mobile computing device, including a mobile computer or mobile computing device (e.g., a Microsoft® Surface® device, a personal digital assistant (PDA), a laptop computer, a notebook computer, a tablet computer, a netbook, etc.), a desktop computer, a server, a mobile phone or handheld device (e.g., a cell phone, a smart phone, etc.), a wearable computing device (e.g., a head-mounted device including smart glasses, a smart watch, etc.), an Internet-of-Things (IoT) device, or other type of stationary or mobile device. Computing device 102 is not limited to a physical machine, but may include other types of machines or nodes, such as a virtual machine. In an examples, computing device 102 interfaces with other components illustrated in FIG. 1 through APIs and/or by other mechanisms.

In examples, state change initiator 104 is configured to change a state of computing device 102. As used herein, a state change comprises any action that results in a change in an operating state of computing device 102. In various embodiments, the state change comprises a change in the manner in which data is accessed on computing device 102. For instance, the state change comprises a change in a power state (e.g., powering off or shutting down the computing device, entering a low-power state such as a standby mode, a hibernation state change, etc.), a change in a login state (e.g., logging off of an application, service, operating system, etc.), a change in a screensaver state, a change in a lock state (e.g., locking an application, service, operating system, etc.). In various embodiments, the state change comprises changing a state to restrict the access of data on computing device 102.

Change state initiator 104 is configured to change the state of computing device 102 based on one or more triggering events. In some examples, the triggering event includes a user-initiated action (e.g., user 118 interacting with computing device 102 to manually trigger a state change). In various other examples, the triggering event is based on a current usage of computing device 102. For instance, the triggering event comprises a passage of an idle period in which state change initiator 104 determines that computing device 102 is not in use (e.g., based on a lack of keyboard or touchpad/mouse interaction). In another example, the triggering event is based on a determination by state change initiator 104 that user 118 is no longer within a proximity of computing device 102 (e.g., based on a proximity sensor integrated in computing device 102). Using any one or more of such triggers, state change initiator 104 may determine that computing device 102 is not being used by user 118 and initiate a state change (e.g., to restrict access of data on the computing device).

State change blocker 106 comprises any component of computing device 102 that prevents state change initiator 104 from changing a state of computing device 102. In examples, state change blocker 106 comprises a software component (e.g., an application executing on the computing device), a service (e.g., a web service), a notification or alert, a hardware component (e.g., a peripheral device) that interrupts the state change from taking place, or any other component that prevents computing device 102 from changing a state.

Blocking remediator 108 is configured to identity the presence of state change blocker 106 and perform one or more actions to remediate the blocking of a state change. In various examples, blocking remediator 108 determines whether a computing device has been idle for a period of time and/or whether user 118 is no longer within a proximity of computing device 102. If the computer has been idle and/or the user is no longer with a proximity of the computing device, blocking remediator 108 may perform one or more actions, such as generating a notification and/or automatically overriding state change blocker 106 such that state change initiator 104 may change the state of computing device 102 to restrict the access of data thereon. In embodiments, the notification may be provided in various ways, such as on computing device 102 or sent as a message via other means. In some examples, a response is received from user 118 to override state change blocker 106.

In various embodiments, blocking remediator 108 is configured to determine whether sensitive data 110 is accessible on computing device 102. Sensitive data comprises any information that is not intended for viewing by non-authorized individuals (e.g., individuals other than user 118), such as information that is confidential, critical, secure, and/or not otherwise intended for public dissemination. Examples of sensitive data include but are not limited to company records, personal information, educational information, health information, professional information, organizational or company information, banking or other financial records, legal documents, biographic information such as birth certificates, driver's licenses, passports, etc. These examples are illustratively only, and sensitive data 110 includes any other type of data (including both confidential and non-confidential information) stored in any device whether locally and/or on a cloud-based storage in various implementations.

In examples, sensitive data 110 may comprise different levels of sensitivity or confidentiality. For instance, some data may comprise a lower level of sensitivity, while other data may comprise a higher level of sensitivity (e.g., extremely sensitive material). In various embodiments, blocking remediator 108 may determine the level of sensitivity associated with sensitive data 110 in various ways, as will be described in greater detail below. Based on such a determination, blocking remediator 108 may select an appropriate remediation action from a plurality of remediation actions in response to identifying the presence of state change blocker 106.

As discussed above, blocking remediator 108 determines whether sensitive data 110 is accessible on computing device 102 in various ways. In one example, sensitive data 110 is stored local to computing device 102 (e.g., on a memory or storage device of the computing device). In another example, sensitive data 108 is accessible based on an application or service currently running on computing device 102 that provides access to the sensitive data. In another example, sensitive data 108 is accessible based on a user being logged into an application or service that provides access to the sensitive data. In another example, sensitive data 110 is accessible via a cloud, such as via server 112 that hosts one or more cloud resources where sensitive data 110 is stored and/or maintained.

In examples, server 112 comprises any one or more computing devices, servers, services, local processes, remote machines, web services, etc. for hosting, managing, and/or providing access to cloud resource 114 by users of computing device 102 (or other computing devices not expressly shown). For instance, server 112 may comprise a server located on an organization's premises and/or coupled to an organization's local network, a remotely located server, a cloud-based server (e.g., one or more servers in a distributed manner), or any other device or service that may host, manage, and/or provide access to cloud resource 114. Cloud resource 114 includes any type of resource coupled to a network, including but not limited to computing or processing resources, software resources (e.g., software as a service (SaaS), platform as a service (PaaS), etc.), storage resources (e.g., physical storage devices, local storage devices, cloud-based storages, hard disk drives, solid state drives, random access memory (RAM) devices, etc.), databases, etc. While example embodiments are described with respect to cloud resource 114 being accessible via a cloud, it should be understood that this implementation is only intended to be illustrative. Techniques disclosed herein may be implemented with respect to other types of resources (e.g., local resources) that are accessible via other means, such as a local network.

In examples, cloud resource 114 include storage resources for storing any data that is intended to be secure (e.g., not intended for public dissemination). In some examples, cloud resource 114 may be stored in a secure manner, such as via password protection, encryption (e.g., public and private key encryption, symmetric keys, etc.), or any other secure manner as appreciated by those skilled in the relevant arts such that read/write access may be provided only by an administrator (e.g., owner) of the data. In some implementations, cloud resource 114 is accessed by other computing devices via a cloud or web-based portal (including a web browser), via an application executing on computing device 102, via a file explorer, or via other techniques as appreciated by those skilled in the relevant arts.

Implementations are not limited to the illustrative arrangement shown in FIG. 1. For instance, any of the components shown in FIG. 1 may be located in a same computing device, may co-located, or may be located remote from each other. Furthermore, system 100 comprises any number of other storage devices, networks, servers, and/or computing devices coupled in any manner in various embodiments.

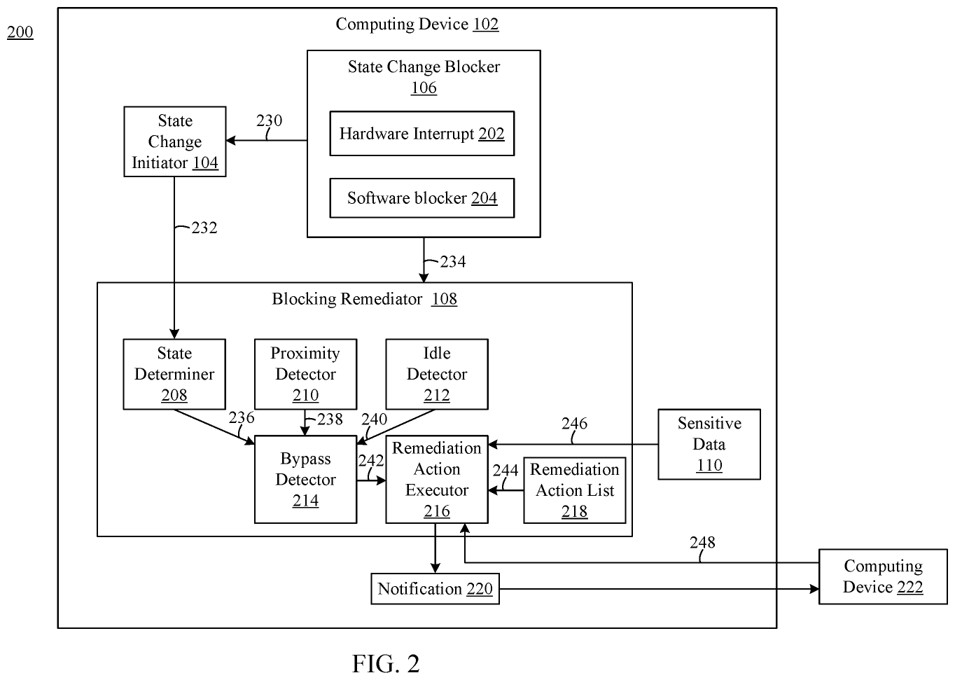

FIG. 2 depicts a block diagram of another system 200 for identifying a bypass of a computing device state change, according to an example embodiment. As shown in FIG. 2, system 200 includes an example implementation of computing device 102 and a computing device 222. Computing device 102 includes example implementations of state change initiator 104, state change blocker 106, blocking remediator 108, and sensitive data 110. Computing device 102 also includes a notification 220 generated by blocking remediator 108. State change blocker 106 includes a hardware interrupt 202 and a software blocker 204. As shown in FIG. 2, blocking remediator includes a state determiner 208, a proximity detector 210, an idle detector 212, a bypass detector 214, a remediation action executor 216, and a remediation action list 218.

In examples, state change blocker 106 comprises one or more components that block state change initiator 104 from changing a state of computing device 102 (e.g., changing the state to restrict the access of data). For instance, hardware interrupt 202 comprises a signal from a hardware component of computing device 102 (which includes any hardware peripherals coupled thereto) that prevents a state change from occurring. For example, a hardware interrupt is generated each time an interaction occurs with a user input device. Such user input devices include, but are not limited to, keyboards, pointing devices (such as a mouse, touchpad, touchscreen), an audio sensor, a camera sensor, etc. When a user input sensor identifies an interaction (whether the interaction occurs intentionally or unintentionally), the hardware component generates a signal indicative of a current user interaction, which prevents state change initiator 104 from changing a state of the computing device.

Software blocker 204 comprises any process executing on computing device 102, which during execution thereof, prevents a state change from occurring on computing device 102. In some examples, the process comprises an application installed on the computing device, such as a web service (e.g., a web browser or other software program) or a desktop application that prevents a state change from occurring when certain types of functionality are utilized, such as during gameplay of a video game, playback of an audio or video (locally stored or streamed via the web), conducting a telephone or conference call (e.g., via the web), etc. In examples, the application, when such functionality is utilized, is configured to transmit a signal to a software component of computing device 102, such as an operating system executing thereon, to prevent the change state from occurring. In some implementations, the application transmits such a signal 230 to the operating system via an API. In various examples, software blocker 204 may prevent the change state from occurring even if the application is minimized or otherwise executing in the background relative to other applications executing on computing device 102. In some implementations, therefore, visibility of certain computing processes that prevent a state change from occurring may not be evident or apparent to user 118 of computing device 102, thereby resulting in an expectation that the computing device will automatically change its state.

State determiner 208 is configured to obtain state information from state change initiator 104. In examples, the state information comprises information indicative of a current state 232 of computing device 102. The current state can be a current power state in some implementations. For instance, the current state comprises information indicating whether the computing device is in a low power state, a standby mode, a hibernation mode, an active mode (e.g., in a normal power mode), a screensaver mode (e.g., whether a screen or display coupled to the computing device is currently on or off), etc. In some implementations, the current state indicates whether the computing device is currently locked or unlocked. In some further implementations, the current state includes information indicating whether state change blocker 106 is blocking a state change from occurring.

Proximity detector 210 is configured to determine a proximity and/or a proximity change 238 of a user of computing device 102. For instance, proximity detector 210 determines whether a user is present within a vicinity (e.g., within a predetermined distance) of computing device 102. In implementations, proximity detector 210 determines whether a user is present within a vicinity of the computing device using one or more techniques, such as based on a sensor (e.g., camera, microphone, Time-of-Flight (ToF), radar, infrared, ultra-wideband sensor, person detection sensor, etc.) of computing device 102, a connection status to a user's device (e.g., the presence or lack of a Bluetooth or other network connection between a user's mobile device such as a smartphone or smartwatch and the computing device), or any type of sensor or connection.

In some implementations, proximity detector 210 is configured to determine a distance between a user (e.g., user 118) and computing device 102. The distance can be determined in various ways, such as via a one or more sensors (e.g., a camera, infrared emitter and/or sensor, microphone, etc.) of computing device 102. In some other examples, the distance can be determined via connection to a network, such as connection to Bluetooth-enabled device (e.g., a smartphone, smartwatch, etc.), cellular network, wireless network (e.g., Wi-Fi), or other network. In some implementations, even if a user is detected in the vicinity of the computing device, proximity detector 210 may determine that the distance of the user is above a threshold (e.g., a user is still in a field of view of a camera of the computing device, but is beyond a threshold distance). In some further examples, a combination of any of the aforementioned techniques are utilized to determine (or approximate) a user's distance from computing device 102. As will be described in greater detail below, the relative distance between a user and the computing device is used in some implementations to determine which remediation action to execute.

Idle detector 212 is configured to detect an idle period 240 of computing device 102 and/or whether the idle period is above a threshold idle period. In examples, the idle period indicates whether computing device 102 is currently being used by user 118. In some implementations, the idle period may be based on identifying the most recent input provided to computing device 102, such as the most recent keystroke, touch input, cursor movement, voice command, etc. In some other implementations, the idle period may be detected based on movement of a user as sensed by one or more sensors of computing device 102 (e.g., a camera, microphone, etc.). In various examples, the threshold idle period comprises a predetermined time above which a determination is made that computing device 102 is not actively in use (e.g., the device is in a state of non-use). When the detected idle period is above such threshold, idle detector 212 is configured to determine that computing device 102 is idle.

In some implementations, proximity detector 210 and idle detector 212 may be combined into a single component. In some examples, proximity detector 210 and/or idle detector 212 may be configured to utilize the same sensor(s) to determine a proximity of the user and determine that the computing device is currently in an idle state.

In example embodiments, bypass detector 214 is configured to determine, based on a signal 234 from state change blocker 106, whether the state change blocker is preventing computing device 102 from changing a state, and cause a remediation action to be performed based on a user proximity and a detection of an idle period. For instance, if a user is viewing a video on computing device 102 that is preventing the computing device from automatically locking and the user walks away from the computing device, bypass detector 214 is configured to determine that the computing device is not locked even though the user is no longer using the computing device. In such a scenario, bypass detector 214 may generate a signal to cause a remediation action to be performed to mitigate the risk sensitive information on computing device 102 from being accessed by others. In examples, bypass detector 214 may operate in various ways, as will be described in greater detail below.

Remediation action executor 216 is configured to execute one or more remediation actions in response to bypass detector 214 making a determination 242 that state change blocker 106 is preventing the computing device from changing a state. In examples, remediation action executor 216 executes a remediation action that is intended to mitigate the risk of sensitive data 110 being accessed by one or more other users (e.g., users other than user 118 that are in the vicinity of computing device 102). In some examples, the remediation action is configured to restrict access to sensitive data 110, such as by changing a state of the computing device (e.g., locking the computing device, logging off and/or terminating an application or operating system via which sensitive data 110 is accessible, entering a standby mode, powering down the computer, blocking an area of a screen that displays sensitive data 110, etc.).

In some other examples, the remediation action comprises notification 220. Notification 220 comprises an indication that is provided to computing device 102 and/or computing device 222. Computing device 222 comprises any separate computing device associated with user 118, such as a smartphone, table, smartwatch, IoT device, headphones, or other device associated with user 118 that is communicatively coupled to computing device 102. An example of such a computing device is described below with reference to FIG. 7.

In examples, notification 220 indicates, to user 118, that computing device 102 has not changed its state even though user 118 is no longer detected in the vicinity thereof. In some implementations, notification 220 comprises an option to override state change blocker 106 such that state change initiator 104 can change the state of computing device 102. For instance, the option may comprise a hyperlink, such that when selected by a user, causes state change blocker 106 to be overridden. In another example, the option comprises the ability for a user to provide a user-input (e.g., by responding to the notification or sending a message) indicating that computing device 102 should change its state. In some other examples, a specific type of state change is provided in a response, such as locking the computing device, logging off of an application or operating system, entering a standby mode, or other type of state change that restricts the access of sensitive data 110. In example embodiments, by allowing a user to select an option to override state change blocker 106 (e.g., by responding to a notification), a state change can be forced on computing device 102 in a manner that reduces or even eliminates the likelihood that sensitive information accessible on the computing device is disclosed to non-authorized individuals. As a result, the security of the computing device and/or the contents stored thereon is improved, in addition to other advantages described herein (e.g., reduction of computing resources). Further examples of notification 220 will be provided in greater detail below.

In various implementations, remediation action executor 216 is configured to select the one or more remediation actions 244 from remediation action list 218. Remediation action list 218 comprises a listing of actions to execute based on one or more factors described herein, such as a location or current physical environment of the computing device (e.g., whether the computing device is in a public location such as a library or coffee shop, in a private location such as the user's home, or in an office), an actual or estimated distance of user 118 relative to the computing device, a length of time the device has been idle, the confidentiality level of sensitive data 110, a security policy (e.g., as defined by an organization or a user), the manner in which sensitive data 110 is accessible in its current state (e.g., whether it is displayed on a screen, is accessible via an application that is currently logged in, etc.). In examples, based on any one or more of these illustrative factors (or other factors not expressly described), remediation action list 218 may provide an associated remediation action that is to be executed.

As discussed above, the selected action for execution by remediation action executor 216 is based on a proximity change in some implementations. In some examples, the action is selected from a plurality of actions from remediation action list 218 based on the proximity change (e.g., a relative distance between the user and the computing device). For example, where the user has moved beyond a threshold distance relative to computing device 102 but is still in the vicinity of thereof, a first type of remediation action can be performed (e.g., generating an on-screen notification or other local notification). In another example, such as where the user has left the vicinity of the computing device, a different type of notification can be selected (e.g., a text message, email message, a voice message, etc.) provide to computing device 222) and/or automatically enacting a state change on the computing device to restrict the access of data by overriding the blocking of the state change. Thus, in various embodiments, the selection and execution of the remediation action can be dependent on the proximity between the user and the computing device, in addition and/or as an alternative to one or more other factors described herein.

As discussed above, computing device 102 comprises various types of sensors that are used to detect the presence of user 118. In some implementations, a camera, microphone, and/or associated software of computing device 102 is configured to perform an identification of user 118 and/or one or more other users in the vicinity of the computing device using various types of techniques, such as facial recognition, voice recognition, or other biometric-based recognition. Based on the identity of the detect user(s), remediation action executor 216 may select a corresponding type of action to execute. For instance, if a user other than user 118 is detected in the vicinity of computing device 102, computing device, remediation action executor 216 may automatically change a state of the computing device to restrict access of sensitive data 110 and/or transmit an appropriate notification to user 118.

In some other implementations, remediation action executor 216 may implement one or more machine-learning (ML) or other artificial intelligence techniques in determining the action to execute. For instance, ML techniques are utilized to learn behaviors of user 118 with respect to computing device 102, environments that computing device 102 is present (e.g., public or private networks that are utilized), applications that are currently executing, how the user presence was detected, the types of data that are accessed, the time of day or day of the week when the data is accessed, and/or other behaviors associated with the use of the device. A ML model can subsequently be trained based on such information, which is then used to identify which type of action to execute and/or the timing of when such actions would occur after a proximity change is detected. In some further examples, user responses to notifications are also learned using ML techniques, such as which actions users execute in response to receiving a notification of a state change blocker. In such instances, remediation action executor 216 may utilize the ML model to automatically execute various types of actions (e.g., state changes) that the user has been observed to execute in the past.

In some implementations, the listing of remediation actions may be stored in a hierarchy or prioritized list, such that one or more actions have a higher priority than other actions based on the various factors described. Thus, depending upon the particular circumstances of the environment surrounding computing device 102, different remediation actions may be selected and executed to minimize the risk of sensitive data 110 being accessed by other users.

In various embodiments, any of the components of the systems described herein are implemented in various forms. For instance, any of the components of the disclosed systems (or subcomponents thereof) can be implemented as software (e.g., as part of an operating system or a separate software application), and/or implemented on a separate (e.g., standalone) hardware chip or microcontroller that is coupled to computing device 102.

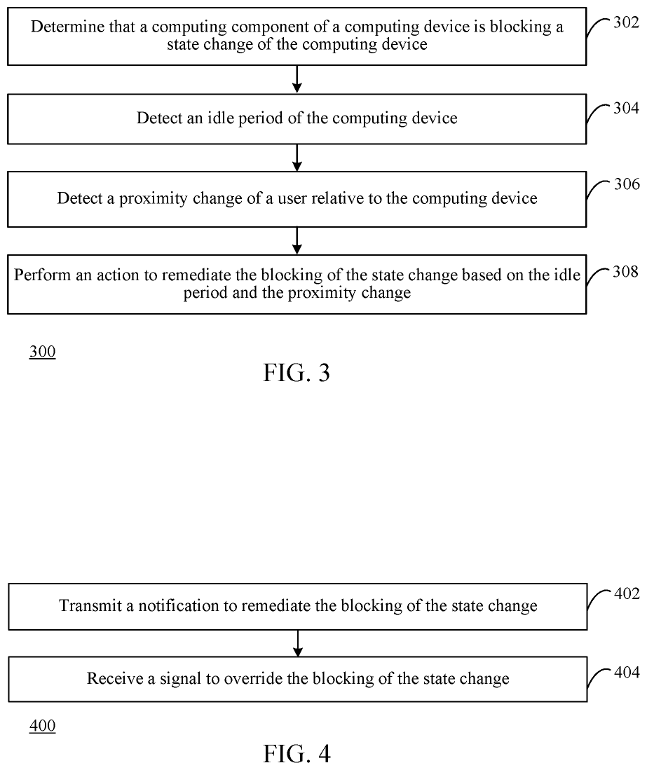

In accordance with one or more embodiments, a bypass of a computing device state change is identified. For example, FIG. 3 shows a flowchart 300 of a method for identifying a bypass of a state change of a computing device, in accordance with an example embodiment. In an embodiment, flowchart 300 is implemented by system 100 as shown in FIG. 1 and/or system 200 as shown in FIG. 2. Accordingly, flowchart 300 will be described with reference to FIGS. 1 and 2. Other structural and operational embodiments will be apparent to persons skilled in the relevant art(s) based on the following discussion regarding flowchart 300, system 100 of FIG. 1 and system 200 of FIG. 2.

Flowchart 300 begins with step 302. In step 302, a determination is made that a computing component of a computing device is blocking a state change of the computing device. For instance, with reference to FIG. 2, bypass detector is configured to determine that state change blocker 106 is blocking a state change of computing device 102. As discussed above, state change blocker 106 comprises any computing component that prevents state change initiator 104 from changing a state of computing device 102, such as an automatic state change that causes computing device 102 to enter a different power state, standby state, logon or logoff state, screever state, etc. In examples, state change blocker 106 includes a hardware component that generates a hardware interrupt, a software component that comprises an application, service, etc., or any other component of computing device 102 that suppresses a state change from automatically occurring, even if the computing device is idle or a user is no longer within the vicinity thereof. In various implementations, state change blocker 106 may prevent the state change from occurring by communicating with (e.g., sending a signal to) an operating system or other software of computing device 102, such as via an API.

In step 304, an idle period of the computing device is detected. For instance, with reference to FIG. 2 idle detector 212 is configured to detect an idle period of computing device 102, such as a length of time that computing device 102 is not actively being used. In some examples, idle detector 212 determines whether any interrupts are received from a hardware peripheral (e.g., a keyboard input or a mouse or touch screen interaction), or any other user-inputs are received (e.g., voice inputs). In some examples, idle detector 212 is further configured to determine if the detected idle period is above a threshold idle period, the threshold idle period indicative of the computing device not being actively used. In such examples, when the idle period surpasses the threshold, a determination is therefore made that the computing device is not in active use (e.g., the computing device is idle).

In step 306, a proximity change of a user relative to the computing device is detected. For instance, with reference to FIG. 2, proximity detector 210 is configured to detect a proximity change of user 118 relative to computing device 102. In some examples, the proximity change comprises an indication that the user is no longer within a vicinity (e.g., a predetermined distance) of computing device 102. In other examples, the proximity change comprises an indication that user 118 has moved to a distance beyond a threshold distance or has otherwise moved away from the computing device. In other examples, the proximity change comprises an indication of an actual or estimated distance of the user relative to computing device 102.

Proximity detector 210 detects the proximity change in various ways as described herein, such as based on one or more sensors of computing device 102 (e.g., camera, radar, ToF, person sensor, ultra-wideband sensor, microphone, etc.), a connectivity or coupling (e.g., Bluetooth connection) between computing device 222 and computing device 102 (or between computing device 222 and another computing device or network not shown), or in various other ways as will be appreciated by those skilled in the relevant arts.

In step 308, an action is performed to remediate the blocking of the state change based on the idle period and the proximity change. For instance, with reference to FIG. 3, remediation action executor 216 is configured to perform one or more actions to remediate the blocking of the state change by state change blocker 106. In implementations, remediation action executor 216 selects the action(s) from remediation action list 218 based on any one or more factors, as described herein. For example, remediation action executor 216 may select a different action to perform based on the distance of user 118 relative to the computing device (or whether the user is within a vicinity at all), a sensitivity level 246 of sensitive data 110 that is accessible via computing device 102, a security policy defined for the computing device and/or sensitive data 110, or various other factors as described.

In various embodiments, remediation action executor 216 performs the remediation action relatively quickly (e.g., immediately) upon proximity detector 210 detecting a proximity change of user 118. For instance, remediation action executor 216 provides a notification upon user 118 walking away from computing device 102. In some other embodiments, remediation action executor 216 executes a remediation action after a time period has passed (e.g., an alarm timeout period) in which the user has not returned to the computing device.

In examples, the operation of remediation action executor 216 may be configured manually and/or automatically (e.g., via a configuration portal or other interface), such as the timeout period and/or the remediation actions to perform (e.g., notification methods) under various types of circumstances. For instance, the alarm time out period can be configured based on a user-specified time period, or may be based on various other factors as described herein. For example, if computing device 102 is in a public place (e.g., a coffee shop or library) and/or is coupled to a public network (e.g., a public Wi-Fi network), the alarm timeout can be set to a relatively short period (e.g., instant or within a few seconds) such that the remediation action is executed quicker. In a further implementation, such as where the remediation action is the generation and/or transmission of a notification, the notification can be configured to comprise a text message sent over a cellular network to computing device 222 in such instances.

In other examples, such as where computing device 102 is located at a user's home and/or is connected to a home wireless network, the timeout period can be relatively longer and a different type of remediation action can be selected (e.g., sending an email, generating a home assistant message). As described herein, the remediation action is not limited to generating a notification. Rather, various examples comprise forcing a state change of computing device 102 to restrict access of sensitive data 110, as described herein. Thus, in various implementations, a user can access a portal (e.g., via computing device 102 or via another computing device) that defines the circumstances in which remediation actions (e.g., state changes and/or notifications) are determined, the manner in which notifications are generated and/or transmitted, the timeout period for executing the actions, or any other aspect relating to the operation of blocking remediator 108 as described herein.

In addition, it should be noted that the foregoing examples are only intended to be illustrative of the configuration that may be achieved for the disclosed techniques. Any aspect relating to the operation and/or functionality of blocking remediator 108 (including any subcomponents thereof) can be selectively configured based on the preferences of a user, an organization, or other administrator of computing device 102.

In this manner, remediation action executor 216 may perform an action intended to restrict the access of sensitive data 110 in the event a component is blocking the computing device from automatically changing its state, thereby mitigating the risk of sensitive information being disseminated to unauthorized individuals and improving data security. For instance, as described above, the disclosed techniques allow for user 118 to be aware of the state (e.g., lock status) of their computing device, any components that are blocking a state change, and/or remotely change the state of the computing device to restrict access to data accessible therefrom.

As described above, various types of remediation actions can be performed by remediation action executor 216. For example, FIG. 4 shows a flowchart 400 of a method for transmitting a notification as a remediation action, in accordance with an example embodiment. In an embodiment, flowchart 400 is implemented by system 100 as shown in FIG. 1 and/or system 200 as shown in FIG. 2. Accordingly, flowchart 400 will be described with reference to FIGS. 1 and 2. Other structural and operational embodiments will be apparent to persons skilled in the relevant art(s) based on the following discussion regarding flowchart 400, system 100 of FIG. 1, and system 200 of FIG. 2.

Flowchart 400 begins with step 402. In step 402, a notification is transmitted to remediate the blocking of the state change. For instance, with reference to FIG. 2, one type of remediation action list 218 comprises a notification that is to be generated for presentation on computing device 102 and/or for transmission remotely to computing device 222. For instance, the generated notification indicates that a computing component is blocking an automatic state change from occurring. In some implementations, the notification identifies the current state of the computing device (e.g., an unlock status). In some implementations, the notification identifies the computing component that is blocking the state change. The notification may also identify sensitive data 110 that is at risk of exposure, an application or service from which data is accessible, and/or a current state (e.g., an unlocked state) 236 of the computing device as determined by state determiner 208. In some further implementations, the notification may also indicate that the computing device has been idle for a detected period of time and/or a determination has been made that user 118 is no longer within a vicinity of the device (or any other information detected by proximity detector 210 and/or idle detector 212).

Providing a notification to a user, whether the user is nearby the computing device or relatively further away from the computing device, allows the user to be aware that the computing device has not changed its state automatically, which can result in unauthorized individuals in the vicinity of the computing device accessing the computing device and/or sensitive data available thereon. In response, the user may perform any number of actions, such as returning to the computing device to manually change the state of the device, responding to the notification to force the state change, terminating the component that is blocking the state change, etc. In addition, the notification allows the user to be knowledgeable of computing components that prevent state changes from occurring. Based on this knowledge, appropriate measures can be taken in the future (e.g., terminating such computing components, manually forcing a state change, etc.). Accordingly, providing information to a user regarding state change blocking components allow for numerous ways in which the risk of unintended disclosure of data accessible on computing devices can be mitigated and/or prevented, which can improve data security among other things.

In examples where notification 220 is provided for presentation on computing device 102, the notification can comprise various forms, such as a visual notification that is displayed on a display device coupled to computing device 102 (e.g., as a pop-up, as a notification in a toolbar or taskbar, as a window that is rendered over one or more other components or applications displayed, etc.), an audio notification (e.g., a voice message, alert, sound effect, etc.), a haptic notification, or other types of notifications. In some implementations, remediation action executor 216 may be configured to generate one or more of such notifications to be presented locally in instances where bypass detector 214 determines that user 118 is within a predetermined range or distance of computing device 102, such that user 118 can resolve the notification by returning to computing device 102 (e.g., to resume using the device, to lock the device, perform another action to manually change the state of the device to restrict access of sensitive data 110, or resolve the warning as a false alarm).

In other embodiments, notification 220 is provided for remote transmission to computing device 222. Remediation action executor 216 may select such a notification in instances where bypass detector 214 determines that user 118 is beyond a predetermined range or distance, such that user 118 may not be able to resolve a locally presented notification. In example embodiments, notifications transmitted to computing device 222 include any message transmitted to a computing device other than computing device 102 indicative of the blocking of the state change (e.g., as described above). For example, such a notification can include a text message (e.g., SMS or MMS message transmitted to a mobile device) transmitted over a network (e.g., a local network, a wireless network, a cellular network, etc.), an email message, a voice message such as a phone call or voicemail, a home assistant or other home automation message (e.g., provided as a voice message or other alert).

In various other implementation, notification 220 is generated for transmission to other endpoint devices, such as a device utilized by an administrator (e.g., IT personnel) of computing device 102, a supervisor of user 118, or a server in which notifications are logged (e.g., for data analytics, such as machine-learning).

In step 404, a signal is received to override the blocking of the state change. For instance, with reference to FIG. 2, computing device 222 is configured to send a response 248 (e.g., based on a user input on computing device 222) to remediation action executor 216 that comprises a signal to override the blocking of the state change. The response indicates, for instance, that state change initiator 104 should force a state change, despite state change blocker 106 attempting to block such a state change. In some examples, a computing process associated with state change blocker 106 is terminated such that state change initiator 104 can proceed with changing the state of the computing device.

In this manner, user 118 may remotely override state change blocker 106 and force a state change in instances where the user is not within a vicinity of computing device 102. In examples, any one or more of the state changes described herein can be implemented based on response 248.

In various implementations, response 248 can be transmitted in accordance with one or more techniques, such as by a user 118 interacting with a hyperlink or other interactive link, transmitting a message (e.g., a text message, email message, chat message, etc.), interacting with a selectable element of an application or web interface accessible on computing device 222, or other user input on computing device 222. In some examples, response 248 specifies a remediation action to be performed (or selects one of a plurality of recommended remediation actions provided in notification 220), based on a user input received on computing device 222.

It should be noted that example embodiments are not limited to forcing a state change of computing device 102 in response to a signal received from computing device 222 or after a notification is generated. For instance, in some implementations, remediation action executor 216 is configured to select an action to override the blocking of the state change and force a state change as described herein (e.g., by powering off a device, entering a standby mode, logging off of an application, etc.) automatically or without a user input. In some implementations, as described herein, the automatic overriding is performed based on a proximity change (e.g., when the user is determined to have left the vicinity of the computing device). In some other examples, remediation action executor 216 is configured to automatically force a state change and subsequently transmit notification 220 to computing device 222, indicating that a state change has taken place.

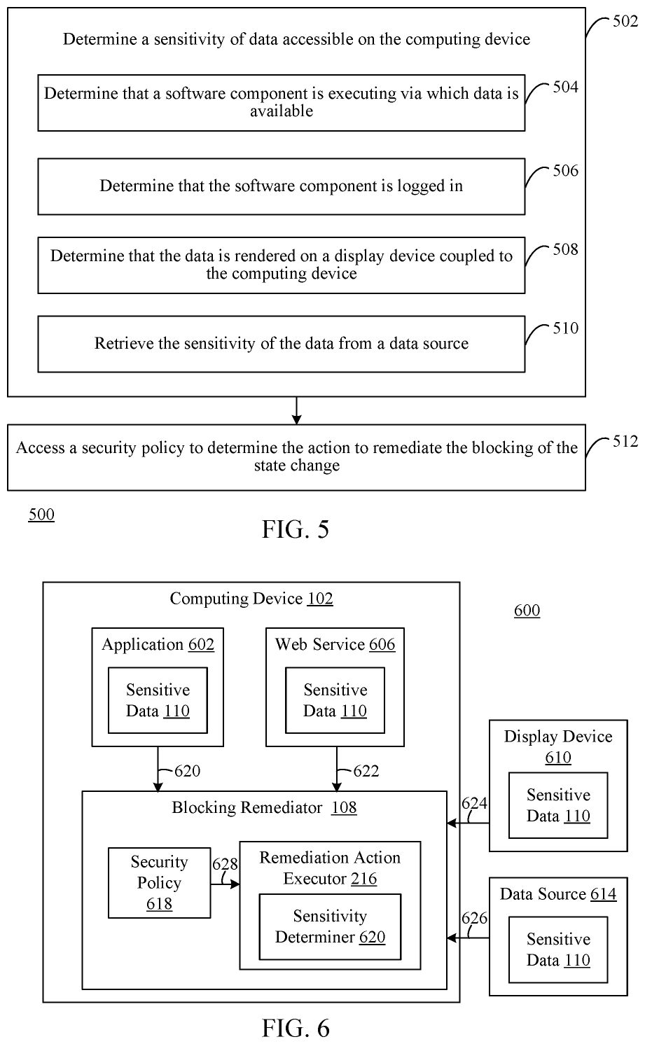

In accordance with various embodiments, a sensitivity level of sensitive data 110 is taken into account in selecting an appropriate remediation action. For example, FIG. 5 shows a flowchart 500 of a method for accessing a security policy to identify a remediation action based on a sensitivity of data, in accordance with an example embodiment. In an embodiment, flowchart 500 is implemented by system 100 as shown in FIG. 1, system 200 as shown in FIG. 2, and/or a system 600 as shown in FIG. 6. Accordingly, flowchart 500 will be described with reference to FIGS. 1, 2, and 6. FIG. 6 shows a block diagram of a system 600 for identifying a remediation action based on a sensitivity of data accessible on a computing device, in accordance with an embodiment. As shown in FIG. 6, system 600 includes an example implementation of computing device 102, a display device 610, and a data source 614. Computing device 102 includes an application 602, a web service 606, and an example implementation of blocking remediator 108. Blocking remediator 108 comprises a security policy 618 and an example implementation of remediation action executor 216. Remediation action executor 216 includes a sensitivity determiner 620. As shown in FIG. 6, application 602, web service 606, display device 610, and data source 614 include an example implementation of sensitive data 110. It should be understood that examples need not include each of application 602, web service 606, display device 610, and data source 614. Rather in some implementations, one or more of the foregoing components may not be present. Other structural and operational embodiments will be apparent to persons skilled in the relevant art(s) based on the following discussion regarding flowchart 500, system 100 of FIG. 1, system 200 of FIG. 2, and system 600 of FIG. 6.

Flowchart 500 begins with step 502. In step 502, a sensitivity of data accessible on the computing device is determined. For instance, with reference to FIG. 6, sensitivity determiner 620 is configured to determine a sensitivity of sensitive data 110 that is accessible on computing device 102. In examples, the sensitivity of sensitive data 110 comprises one of a plurality of sensitivity levels (e.g., as a grade or numerical value) or designations (e.g., non-confidential, confidential, highly confidential, etc.) indicative of level of sensitivity of information contained therein. In some other examples, the sensitivity comprises an indication of whether sensitive data is accessible (e.g., irrespective of a particular level of sensitivity of the data).

In implementations, sensitivity determiner 620 determines the sensitivity of sensitive data 110 in various ways, including but not limited to one or more of the techniques shown in steps 504, 506, 508, and/or 510. In step 504, it is determined that a software component is executing on the computing device via which the data is available. For instance, sensitivity determiner 620 is configured to determine that application 602 and/or web service 606 are executing on computing device 102 via which sensitive data 110 is available. Application 602 comprises any software (including the operating system of computing device 102) which is used to view, copy, transmit, modify, or otherwise access sensitive data 110 that may be stored locally or remotely to computing device 102. For example, application 602 can comprise a database application, financial application, file explorer, etc. for accessing data (e.g., files, folders, databases, multimedia content, etc.) that is stored in any form. In accordance with the above techniques for determining a sensitivity of data based on whether a software component is executing, the sensitivity therefore can be determined with reduced processing cycles. For instance, in instances where it is predefined that certain software components themselves are sensitive (e.g., due to those components being used to access sensitive data), additional processing resources need not be utilized to determine the sensitivity of individual pieces of data (e.g., files, databases, etc.). Rather, a determination may be made that a sensitivity is present based on a currently executing software component, after which an appropriate remediation action is executed.

Web service 606 comprises a web-based interface (which includes a web browser) that is used to view, copy, transmit, modify, or otherwise access sensitive data 110 that may be stored locally or remotely to computing device 102. For example, web service 606 comprises a cloud-based service that is used to access one or more items of data that is stored on a cloud-based server (e.g., cloud resource 114 accessible via server 112).

In various implementations, sensitivity determiner 620 determines whether application 602 and/or web service 606 is executing. In some further implementations, sensitivity determiner 620 determines whether sensitive data 110 is accessible via application 602 and/or web service 606 (e.g., whether such data is currently open or being accessed.

In step 506, it is determined that a software component is logged in via which the data is available. For example, with reference to FIG. 6, sensitivity determiner 620 determines whether application 602 and/or web service 606 are logged in (or signed in) using the credentials of an authorized account (e.g., user 118). For instance, in some implementations, application 602 and/or web service 606 may be executing but a user is not logged in, which prevents sensitive data from being accessible. In such instances, a one type of remediation action may be executed (e.g., providing only a notification to a user). In other instances, such as where a user is logged in to application 602 and/or web service 606, sensitivity determiner 620 may determine that sensitive data 110 is accessible via such software components, and therefore cause a different type of remediation action to be executed (e.g., automatically logging out of the account, terminating the application, locking the computer, etc.) that restricts the access (or potential access) of such data.

As discussed above, these techniques similarly allow for determining a sensitivity with reduced processing cycles. For instance, it may be predefined (e.g., in a security policy or the like) that certain software components that are currently logged in raises the risk of sensitive data being disclosed to unauthorized individuals (e.g., due to those components, when logged in, being used to access sensitive data). Thus, rather than utilizing processing resources to determine the sensitivity for individual pieces of data that are accessible on computing device 102, identifying the presence of a logged-in software component that simply provides access to sensitive data can be used to determine that sensitive data is potentially accessible. Based on such information, one or more actions are taken to remediate the risk of disclosure of sensitive data, as described elsewhere herein.

In step 508, a determination is made that the data is rendered on a display device coupled to the computing device. For instance, with reference to FIG. 6, sensitivity determiner 620 is configured to determine whether sensitive data 110 is rendered on display device 610 coupled to computing device 110. Display device comprises a screen or other output device (e.g., as described below with reference to FIG. 7) coupled to, or integral to, computing device 102, via which data accessed by computing device 102 is rendered. When sensitive data 110 is presently rendered on display device 610, sensitivity determiner 620 may determine that sensitive data is viewable by users other than user 118 that are in the vicinity of computing device 102, and cause one or more remediation actions to be executed in response.

In examples, sensitivity determiner 620 determines whether sensitive data 110 is rendered on display device 610 in various ways. In one implementation, sensitivity determiner 620 analyzes (e.g., crawls) the content rendered on display device 610 to identify any content indicative of sensitive information. For instance, sensitivity determiner 620 is configured to analyze headers or footers containing confidentiality designations, text or images in data that is rendered using optical character recognition or the like, names of files or folders that are open or visible, or computing processes that are currently executing. In some implementations, sensitivity determiner 620 is configured to analyze content rendered on display device 610 using one or more artificial intelligence models (e.g., machine learning models, neural network models, etc.) to determine whether the currently rendered data is sensitive (and/or determine an associate sensitivity level).

In examples where the sensitivity determination is made based on data rendered on a display, as described above, the accuracy of determining the sensitivity of data can be improved. For instance, such techniques would allow for the sensitivity determination to be made with respect to data that is actually rendered (as opposed to requiring user interactions at the computing device to locate and access data). In other words, these techniques allow for the sensitivity determination to specifically correspond to the data that is on the display device, which can result in fewer false positives. In addition, where sensitive data is currently rendered on a screen, an unauthorized entity in the vicinity of the computing device may be able to view sensitive information without any level of interaction with the device, which raises the risk of an unauthorized disclosure. By detecting instances where sensitive data is being rendered, appropriate actions can be taken (e.g., automatically lock the device with a shorter timeout period) to reduce the disclosure risk.

In step 510, the sensitivity of the data is retrieved from a data source. For instance, sensitivity determiner 620 retrieves a sensitivity of sensitive data 110 from data source 614. In embodiments, data source 614 comprises a storage device, storage location, or computing component from which data is accessible (e.g., a local storage device, a cloud-based storage, an application, a web service, a cloud, a server, etc.). The data source may be local to or remote from computing device 102. In one example, the sensitivity is retrieved from metadata associated with sensitive data 110 that indicates the sensitivity level of such data. In another example, sensitivity determiner 620 obtains the sensitivity level based on a communication with data source 614 (such as by querying the data source for the sensitivity). In another example, sensitivity determiner 620 extracts the sensitivity based on an analysis of sensitive data 110. In various examples, the sensitivity of sensitive data 110 can be predefined (e.g., by a user or administrator) and/or assigned automatically.

It should be noted that example embodiments are not limited to performing actions based on the sensitivity of data accessible on computing device 102, but may also be based on other factors as well. For example, sensitivity determiner 620 determines in some embodiments that a particular software component (e.g., application 602 or web service 606) is sensitive and/or determines a sensitivity level associated therewith. Such a sensitivity indication or sensitivity level may be predefined in some examples (e.g., based on a security policy), defined by a user, or assigned automatically in some cases.

In some other examples, the sensitivity level is determined based on a user, organization, or cloud account that is logged in or otherwise associated with a software component. For instance, a particular cloud account that is accessible via web service 606 may be associated with a particular sensitivity (e.g., highly confidential), while another cloud account accessible via web service 606 comprises a lower or different sensitivity level. In examples, different sensitivity levels may result in different types of remediation actions being executed to restrict the access of data.

Retrieving the sensitivity of data from a data source allows for improved accuracy of the sensitivity determination, as the retrieved sensitivity may be associated with the underlying data (or an application/provider/host that provides access to the data). In other words, the retrieved sensitivity may be tailored to the data, resulting in fewer false positive remediation actions. In addition, since the sensitivity is retrieved from another data source (as opposed to expending processing cycles to analyze the data to determine its sensitivity in some implementations), the sensitivity is determined with fewer processing cycles, thereby improving the overall efficiency of the computing system.

In step 512, a security policy is accessed to determine the action to remediate the blocking of the state change. For instance, with reference to FIG. 6, remediation action executor 216 accesses security policy 618 to determine which action (e.g., from remediation action list 218) to execute to remediate the blocking of the state change by state change blocker 106. In examples, security policy 618 comprises a mapping that indicates, for each different type of sensitivity as determined by sensitivity determiner 620, a corresponding remediation action. Security policy 618 may be configured via a suitable portal, accessible via computing device 102 or via another device (e.g., of an administrator). In some implementations, security policy 618 is provided to computing device 102 by an administrator or other entity that owns computing device 102 or manages the security thereof.

For instance, security policy 618 indicates that for a given sensitivity (which may be an indication that sensitive data is accessible and/or a sensitivity level thereof), a particular type of remediation action should be executed. For example, where data is not sensitive or an application in which sensitive data is accessible is not currently logged in, a first set of remediation actions can be executed (e.g., transmitting a notification to a user). In another example, where the application is logged in or the sensitive data is highly confidential, one or more other remediation actions can be executed, such as automatically signing out of the application, locking the computer, or otherwise changing the state of the computing device to restrict the access of the sensitive data (as an alternative to, or in addition to generating a notification). In some other examples, different types of notifications can be provided or different types of state changes can be executed based on the determined sensitivity. Thus, in various embodiments, the remediation action can be determined dynamically based on the current operation of computing device 102 (which includes whether sensitive data is accessible, the sensitivity level of such data, software components that are executing, the environment in which computing device 102 is present, or various other factors described herein). It should be noted that these examples are only illustrative, and security policy may be configured in any suitable way, such as by causing any one or more actions to be performed irrespective of whether sensitive data is accessible on the computing device.

### III. Example Mobile Device and Computer System Implementation

As noted herein, the embodiments described, along with any circuits, components and/or subcomponents thereof, as well as the flowcharts/flow diagrams described herein, including portions thereof, and/or other embodiments, may be implemented in hardware, or hardware with any combination of software and/or firmware, including being implemented as computer program code (program instructions) configured to be executed in one or more processors and stored in a computer readable storage medium, or being implemented as hardware logic/electrical circuitry, such as being implemented together in a system-on-chip (SoC), a field programmable gate array (FPGA), and/or an application specific integrated circuit (ASIC). A SOC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 7. FIG. 7 shows a block diagram of an exemplary computing environment 700 that includes a computing device 702. Computing device 702 is an example of computing device 102, server 112, and/or computing device 222, which may include one or more of the components of computing device 702. In some embodiments, computing device 702 is communicatively coupled with devices (not shown in FIG. 7) external to computing environment 700 via network 704. Network 704 comprises one or more networks such as local area networks (LANs), wide area networks (WANs), enterprise networks, the Internet, etc., and may include one or more wired and/or wireless portions. Network 704 may additionally or alternatively include a cellular network for cellular communications. Computing device 702 is described in detail as follows.

Computing device 702 can be any of a variety of types of computing devices. For example, computing device 702 may be a mobile computing device such as a handheld computer (e.g., a personal digital assistant (PDA)), a laptop computer, a tablet computer (such as an Apple iPad™), a hybrid device, a notebook computer (e.g., a Google Chromebook™ by Google LLC), a netbook, a mobile phone (e.g., a cell phone, a smart phone such as an Apple® iPhone® by Apple Inc., a phone implementing the Google® Android™ operating system, etc.), a wearable computing device (e.g., a head-mounted augmented reality and/or virtual reality device including smart glasses such as Google® Glass™, Oculus Rift® of Facebook Technologies, LLC, etc.), or other type of mobile computing device. Computing device 702 may alternatively be a stationary computing device such as a desktop computer, a personal computer (PC), a stationary server device, a minicomputer, a mainframe, a supercomputer, etc.

As shown in FIG. 7, computing device 702 includes a variety of hardware and software components, including a processor 710, a storage 720, one or more input devices 730, one or more output devices 750, one or more wireless modems 760, one or more wired interfaces 780, a power supply 782, a location information (LI) receiver 784, and an accelerometer 786. Storage 720 includes memory 756, which includes non-removable memory 722 and removable memory 724, and a storage device 790. Storage 720 also stores an operating system 712, application programs 714, and application data 716. Wireless modem(s) 760 include a Wi-Fi modem 762, a Bluetooth modem 764, and a cellular modem 766. Output device(s) 750 includes a speaker 752 and a display 754. Input device(s) 730 includes a touch screen 732, a microphone 734, a camera 736, a physical keyboard 738, and a trackball 740. Not all components of computing device 702 shown in FIG. 7 are present in all embodiments, additional components not shown may be present, and any combination of the components may be present in a particular embodiment. These components of computing device 702 are described as follows.

A single processor 710 (e.g., central processing unit (CPU), microcontroller, a microprocessor, signal processor, ASIC (application specific integrated circuit), and/or other physical hardware processor circuit) or multiple processors 710 may be present in computing device 702 for performing such tasks as program execution, signal coding, data processing, input/output processing, power control, and/or other functions. Processor 710 may be a single-core or multi-core processor, and each processor core may be single-threaded or multithreaded (to provide multiple threads of execution concurrently). Processor 710 is configured to execute program code stored in a computer readable medium, such as program code of operating system 712 and application programs 714 stored in storage 720. The program code is structured to cause processor 710 to perform operations, including the processes/methods disclosed herein. Operating system 712 controls the allocation and usage of the components of computing device 702 and provides support for one or more application programs 714 (also referred to as “applications” or “apps”). Application programs 714 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein.

Any component in computing device 702 can communicate with any other component according to function, although not all connections are shown for ease of illustration. For instance, as shown in FIG. 7, bus 706 is a multiple signal line communication medium (e.g., conductive traces in silicon, metal traces along a motherboard, wires, etc.) that may be present to communicatively couple processor 710 to various other components of computing device 702, although in other embodiments, an alternative bus, further buses, and/or one or more individual signal lines may be present to communicatively couple components. Bus 706 represents one or more of any of several types of bus structures, including a memory bus or memory controller, a peripheral bus, an accelerated graphics port, and a processor or local bus using any of a variety of bus architectures.

Storage 720 is physical storage that includes one or both of memory 756 and storage device 790, which store operating system 712, application programs 714, and application data 716 according to any distribution. Non-removable memory 722 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 722 may include main memory and may be separate from or fabricated in a same integrated circuit as processor 710. As shown in FIG. 7, non-removable memory 722 stores firmware 718, which may be present to provide low-level control of hardware. Examples of firmware 718 include BIOS (Basic Input/Output System, such as on personal computers) and boot firmware (e.g., on smart phones). Removable memory 724 may be inserted into a receptacle of or otherwise coupled to computing device 702 and can be removed by a user from computing device 702. Removable memory 724 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 790 may be present that are internal and/or external to a housing of computing device 702 and may or may not be removable. Examples of storage device 790 include a hard disk drive, a SSD, a thumb drive (e.g., a USB (Universal Serial Bus) flash drive), or other physical storage device.

One or more programs may be stored in storage 720. Such programs include operating system 712, one or more application programs 714, and other program modules and program data. Examples of such application programs may include, for example, computer program logic (e.g., computer program code/instructions) for implementing one or more of state change initiator 104, state change blocker 106, blocking remediator 108, sensitive data 110, cloud resource 114, hardware interrupt 202, software blocker 204, state determiner 208, proximity detector 210, idle detector 212, bypass detector 214, remediation action executor 216, remediation action list 218, application 602, web service 606, display data source 614, security policy 618, and/or sensitivity determiner 620, along with any components and/or subcomponents thereof, as well as any other features illustrated and/or described herein, including portions thereof, and/or further examples described herein.

Storage 720 also stores data used and/or generated by operating system 712 and application programs 714 as application data 716. Examples of application data 716 include web pages, text, images, tables, sound files, video data, and other data, which may also be sent to and/or received from one or more network servers or other devices via one or more wired or wireless networks. Storage 720 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 702 through one or more input devices 730 and may receive information from computing device 702 through one or more output devices 750. Input device(s) 730 may include one or more of touch screen 732, microphone 734, camera 736, physical keyboard 738 and/or trackball 740 and output device(s) 750 may include one or more of speaker 752 and display 754. Each of input device(s) 730 and output device(s) 750 may be integral to computing device 702 (e.g., built into a housing of computing device 702) or external to computing device 702 (e.g., communicatively coupled wired or wirelessly to computing device 702 via wired interface(s) 780 and/or wireless modem(s) 760). Further input devices 730 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 754 may display information, as well as operating as touch screen 732 by receiving user commands and/or other information (e.g., by touch, finger gestures, virtual keyboard, etc.) as a user interface. Any number of each type of input device(s) 730 and output device(s) 750 may be present, including multiple microphones 734, multiple cameras 736, multiple speakers 752, and/or multiple displays 754.

One or more wireless modems 760 can be coupled to antenna(s) (not shown) of computing device 702 and can support two-way communications between processor 710 and devices external to computing device 702 through network 704, as would be understood to persons skilled in the relevant art(s). Wireless modem 760 is shown generically and can include a cellular modem 766 for communicating with one or more cellular networks, such as a GSM network for data and voice communications within a single cellular network, between cellular networks, or between the mobile device and a public switched telephone network (PSTN). Wireless modem 760 may also or alternatively include other radio-based modem types, such as a Bluetooth modem 764 (also referred to as a “Bluetooth device”) and/or Wi-Fi modem 762 (also referred to as an “wireless adaptor”). Wi-Fi modem 762 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 764 is configured to communicate with another Bluetooth-capable device according to the Bluetooth short-range wireless technology standard(s) such as IEEE 802.15.1 and/or managed by the Bluetooth Special Interest Group (SIG).

Computing device 702 can further include power supply 782, LI receiver 784, accelerometer 786, and/or one or more wired interfaces 780. Example wired interfaces 780 include a USB port, IEEE 1394 (Fire Wire) port, a RS-232 port, an HDMI (High-Definition Multimedia Interface) port (e.g., for connection to an external display), a DisplayPort port (e.g., for connection to an external display), an audio port, an Ethernet port, and/or an Apple® Lightning® port, the purposes and functions of each of which are well known to persons skilled in the relevant art(s). Wired interface(s) 780 of computing device 702 provide for wired connections between computing device 702 and network 704, or between computing device 702 and one or more devices/peripherals when such devices/peripherals are external to computing device 702 (e.g., a pointing device, display 754, speaker 752, camera 736, physical keyboard 738, etc.). Power supply 782 is configured to supply power to each of the components of computing device 702 and may receive power from a battery internal to computing device 702, and/or from a power cord plugged into a power port of computing device 702 (e.g., a USB port, an A/C power port). LI receiver 784 may be used for location determination of computing device 702 and may include a satellite navigation receiver such as a Global Positioning System (GPS) receiver or may include other type of location determiner configured to determine location of computing device 702 based on received information (e.g., using cell tower triangulation, etc.). Accelerometer 786 may be present to determine an orientation of computing device 702.

Note that the illustrated components of computing device 702 are not required or all-inclusive, and fewer or greater numbers of components may be present as would be recognized by one skilled in the art. For example, computing device 702 may also include one or more of a gyroscope, barometer, proximity sensor, ambient light sensor, digital compass, etc. Processor 710 and memory 756 may be co-located in a same semiconductor device package, such as being included together in an integrated circuit chip, FPGA, or system-on-chip (SOC), optionally along with further components of computing device 702.

In embodiments, computing device 702 is configured to implement any of the above-described features of flowcharts herein. Computer program logic for performing any of the operations, steps, and/or functions described herein may be stored in storage 720 and executed by processor 710.

In some embodiments, server infrastructure 770 may be present in computing environment 700 and may be communicatively coupled with computing device 702 via network 704. Server infrastructure 770, when present, may be a network-accessible server set (e.g., a cloud-based environment or platform). As shown in FIG. 7, server infrastructure 770 includes clusters 772. Each of clusters 772 may comprise a group of one or more compute nodes and/or a group of one or more storage nodes. For example, as shown in FIG. 7, cluster 772 includes nodes 774. Each of nodes 774 are accessible via network 704 (e.g., in a “cloud-based” embodiment) to build, deploy, and manage applications and services. Any of nodes 774 may be a storage node that comprises a plurality of physical storage disks, SSDs, and/or other physical storage devices that are accessible via network 704 and are configured to store data associated with the applications and services managed by nodes 774. For example, as shown in FIG. 7, node 774 may store application data 778.

Each of nodes 774 may, as a compute node, comprise one or more server computers, server systems, and/or computing devices. For instance, a node 774 may include one or more of the components of computing device 702 disclosed herein. Each of nodes 774 may be configured to execute one or more software applications (or “applications”) and/or services and/or manage hardware resources (e.g., processors, memory, etc.), which may be utilized by users (e.g., customers) of the network-accessible server set. For example, as shown in FIG. 7, nodes 774 may operate application programs 776. In an implementation, a node of nodes 774 may operate or comprise one or more virtual machines, with each virtual machine emulating a system architecture (e.g., an operating system), in an isolated manner, upon which applications such as application programs 776 may be executed.

In an embodiment, one or more of clusters 772 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 772 may be a datacenter in a distributed collection of datacenters. In embodiments, exemplary computing environment 700 comprises part of a cloud-based platform such as Amazon Web Services® of Amazon Web Services, Inc., or Google Cloud Platform™ of Google LLC, although these are only examples and are not intended to be limiting.

In an embodiment, computing device 702 may access application programs 776 for execution in any manner, such as by a client application and/or a browser at computing device 702. Example browsers include Microsoft Edge® by Microsoft Corp. of Redmond, Washington, Mozilla Firefox®, by Mozilla Corp. of Mountain View, California, Safari®, by Apple Inc. of Cupertino, California, and Google® Chrome by Google LLC of Mountain View, California.

For purposes of network (e.g., cloud) backup and data security, computing device 702 may additionally and/or alternatively synchronize copies of application programs 714 and/or application data 716 to be stored at network-based server infrastructure 770 as application programs 776 and/or application data 778. For instance, operating system 712 and/or application programs 714 may include a file hosting service client, such as Microsoft® OneDrive® by Microsoft Corporation, Amazon Simple Storage Service (Amazon S3)® by Amazon Web Services, Inc., Dropbox® by Dropbox, Inc., Google Drive™ by Google LLC, etc., configured to synchronize applications and/or data stored in storage 720 at network-based server infrastructure 770.

In some embodiments, on-premises servers 792 may be present in computing environment 700 and may be communicatively coupled with computing device 702 via network 704. On-premises servers 792, when present, are hosted within an organization's infrastructure and, in many cases, physically onsite of a facility of that organization. On-premises servers 792 are controlled, administered, and maintained by IT (Information Technology) personnel of the organization or an IT partner to the organization. Application data 798 may be shared by on-premises servers 792 between computing devices of the organization, including computing device 702 (when part of an organization) through a local network of the organization, and/or through further networks accessible to the organization (including the Internet). Furthermore, on-premises servers 792 may serve applications such as application programs 796 to the computing devices of the organization, including computing device 702. Accordingly, on-premises servers 792 may include storage 794 (which includes one or more physical storage devices such as storage disks and/or SSDs) for storage of application programs 796 and application data 798 and may include one or more processors for execution of application programs 796. Still further, computing device 702 may be configured to synchronize copies of application programs 714 and/or application data 716 for backup storage at on-premises servers 792 as application programs 796 and/or application data 798.

Embodiments described herein may be implemented in one or more of computing device 702, network-based server infrastructure 770, and on-premises servers 792. For example, in some embodiments, computing device 702 may be used to implement systems, clients, or devices, or components/subcomponents thereof, disclosed elsewhere herein. In other embodiments, a combination of computing device 702, network-based server infrastructure 770, and/or on-premises servers 792 may be used to implement the systems, clients, or devices, or components/subcomponents thereof, disclosed elsewhere herein.

As used herein, the terms “computer program medium,” “computer-readable medium,” and “computer-readable storage medium,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 720. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 714) may be stored in storage 720. Such computer programs may also be received via wired interface(s) 780 and/or wireless modem(s) 760 over network 704. Such computer programs, when executed or loaded by an application, enable computing device 702 to implement features of embodiments discussed herein. Accordingly, such computer programs represent controllers of the computing device 702.

Embodiments are also directed to computer program products comprising computer code or instructions stored on any computer-readable medium or computer-readable storage medium. Such computer program products include the physical storage of storage 720 as well as further physical storage types.

### IV. Additional Example Embodiments

A system for identifying a bypass of a computing device state change is disclosed herein. The system includes: a processor; and a memory device that stores program code structured to cause the processor to: determine that a computing component of a computing device is blocking a state change of the computing device; detect an idle period of the computing device; detect a proximity change of a user relative to the computing device; and perform an action to remediate the blocking of the state change based on the idle period and the proximity change.

In one implementation of the foregoing system, the action comprises generating a notification.

In another implementation of the foregoing system, the notification comprises one or more of: an audio notification; a visual notification; a text message; a voice message; or an email message.

In another implementation of the foregoing system, the notification identifies the computing component that is blocking the device state change of the computing device.

In another implementation of the foregoing system, the program code is further structured to cause the processor to: receive a signal, in response to the notification, to override the blocking of the state change.

In another implementation of the foregoing system, the computing component comprises one of: a process executing on the computing device; or a hardware interrupt.

In another implementation of the foregoing system, the action comprises automatically overriding the blocking of the state change.

In another implementation of the foregoing system, the program code is further structured to cause the processor to: determine a sensitivity of data accessible on the computing device; and access a security policy to determine the action to remediate the blocking of the state change.

In another implementation of the foregoing system, the program code is structured to cause the processor to determine the sensitivity of the data accessible on the computing device by at least one of: determining that a software component is executing via which the data is available; determining that the software component is logged in; determining that the data is rendered on a display device coupled to the computing device; or retrieving the sensitivity of the data from a data source.

In another implementation of the foregoing system, the action is selected from a plurality of actions based on the proximity change.

In another implementation of the foregoing system, the state change comprises one of: a standby mode change; a hibernation state change; a screensaver state change; a lock state change; a device shutdown; or a log-off action.

A method for identifying a bypass of a computing device state change is disclosed herein. The method includes: determining that a computing component of a computing device is blocking a state change of the computing device; detecting an idle period of the computing device; detecting a proximity change of a user relative to the computing device; and performing an action to remediate the blocking of the state change based on the idle period and the proximity change.

In one implementation of the foregoing method, the action comprises generating a notification.

In another implementation of the foregoing method, the notification comprises one or more of: an audio notification; a visual notification; a text message; a voice message; or an email message.

In another implementation of the foregoing method, the method further comprises receiving a signal, in response to the notification, to override the blocking of the state change.

In another implementation of the foregoing method, the computing component comprises one of: a process executing on the computing device; or a hardware interrupt.

In another implementation of the foregoing method, the action comprises automatically overriding the blocking of the state change.

In another implementation of the foregoing method, the method further comprises: determining a sensitivity of data accessible on the computing device; and accessing a security policy to determine the action to remediate the blocking of the state change.

A computer-readable storage medium is disclosed herein. The computer-readable storage medium has computer program code recorded thereon that when executed by at least one processor causes the at least one processor to perform a method comprising: determining that a computing component of a computing device is blocking a state change of the computing device; detecting an idle period of the computing device; detecting a proximity change of a user relative to the computing device; and performing an action to remediate the blocking of the state change based on the idle period and the proximity change.

In one implementation of the foregoing computer-readable storage medium, the method further comprises: determining a sensitivity of data accessible on the computing device; and accessing a security policy to determine the action to remediate the blocking of the state change.

### V. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. Furthermore, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

While various embodiments of the present disclosure have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the claimed embodiments should not be limited by any of the above-described exemplary embodiments, but should be defined only in accordance with the following claims and their equivalents.

What is claimed is:

1. A system for identifying a bypass of a computing device state change, the system comprising:
a processor; and
a memory device that stores program code structured to cause the processor to:
determine that a computing component of a computing device is blocking a state change of the computing device;
detect an idle period of the computing device;
detect a proximity change of a user relative to the computing device; and
perform an action to remediate the blocking of the state change based on the idle period and the proximity change.

2. The system of claim 1, wherein the action comprises generating a notification.

3. The system of claim 2, wherein the notification comprises one or more of:
an audio notification;
a visual notification;
a text message;
a voice message; or
an email message.

4. The system of claim 2, wherein the notification identifies the computing component that is blocking the device state change of the computing device.

5. The system of claim 2, wherein the program code is further structured to cause the processor to:
receive a signal, in response to the notification, to override the blocking of the state change.

6. The system of claim 1, wherein the computing component comprises one of:
a process executing on the computing device; or
a hardware interrupt.

7. The system of claim 1, wherein the action comprises automatically overriding the blocking of the state change.

8. The system of claim 1, wherein the program code is further structured to cause the processor to:
determine a sensitivity of data accessible on the computing device; and
access a security policy to determine the action to remediate the blocking of the state change.

9. The system of claim 7, wherein the program code is structured to cause the processor to determine the sensitivity of the data accessible on the computing device by at least one of:
determining that a software component is executing via which the data is available;
determining that the software component is logged in;
determining that the data is rendered on a display device coupled to the computing device; or
retrieving the sensitivity of the data from a data source.

10. The system of claim 1, wherein the action is selected from a plurality of actions based on the proximity change.

11. The system of claim 1, wherein the state change comprises one of:
a standby mode change;
a hibernation state change;
a screensaver state change;
a lock state change;
a device shutdown; or
a log-off action.

12. A method for identifying a bypass of a computing device state change, the method comprising:
determining that a computing component of a computing device is blocking a state change of the computing device;
detecting an idle period of the computing device;
detecting a proximity change of a user relative to the computing device; and
performing an action to remediate the blocking of the state change based on the idle period and the proximity change.

13. The method of claim 12, wherein the action comprises generating a notification.

14. The method of claim 13, wherein the notification comprises one or more of:
an audio notification;
a visual notification;
a text message;
a voice message; or
an email message.

15. The method of claim 13, further comprising:
receiving a signal, in response to the notification, to override the blocking of the state change.

16. The method of claim 12, wherein the computing component comprises one of:
a process executing on the computing device; or
a hardware interrupt.

17. The method of claim 12, wherein the action comprises automatically overriding the blocking of the state change.

18. The method of claim 12, further comprising:
determining a sensitivity of data accessible on the computing device; and
accessing a security policy to determine the action to remediate the blocking of the state change.

19. A computer-readable storage medium having computer program code recorded thereon that when executed by at least one processor causes the at least one processor to perform a method comprising:
determining that a computing component of a computing device is blocking a state change of the computing device;
detecting an idle period of the computing device;
detecting a proximity change of a user relative to the computing device; and
performing an action to remediate the blocking of the state change based on the idle period and the proximity change.

20. The computer-readable storage medium of claim 19, wherein the method further comprises:
determining a sensitivity of data accessible on the computing device; and
accessing a security policy to determine the action to remediate the blocking of the state change.
